(19) United States
(12) Patent Application Publication
(10) Pub. No.: US 2022/0274707 A1
(43) Pub. Date: Sep. 1, 2022

(54) DRONE FOR PAINTING OUTER WALL OF MULTI-STORY BUILDING

(71) Applicant: IVESKY CO., LTD., Busan (KR)

(72) Inventor: Gill Do LEE, Busan (KR)

(73) Assignee: IVESKY CO., LTD., Busan (KR)

(21) Appl. No.: 17/636,944

(22) PCT Filed: Aug. 13, 2020
(86) PCT No.: PCT/KR2020/010767

§ 371 Date: Feb. 21, 2022

(30) Foreign Application Priority Data
Aug. 19, 2019 (KR) 10-2019-0100951

(51) Int. Cl. B64D 1/18; B64C 39/02

(52) U.S. Cl. CPC B64D 1/18; B64C 39/024; B64C 2201/12; B64C 2201/027

(57) ABSTRACT

The present invention relates to a drone for painting an outer wall of a multi-story building and, more specifically, to a painting drone which can float and move in the air and comprises a drone body and a floating and moving part for floating and moving the drone body in the air. A camera unit for obtaining an image of the outer surface of a building is provided on the drone body. Driving wheels for guidance to the outer surface of the building are provided on one surface of the drone body. Absorption angle members are further formed on the drone body in order to absorb the impact from the building. Paint nozzle parts for painting by spraying paint on the outer surface of the building are further formed on the drone body. By using a drone which can float and move in the air to paint an outer wall of a skyscraper, cost or painting the sky scraper can be reduced, the painting work can be simplified, fatal accidents due to falls can be prevented, and painting time can be shortened.

### TECHNICAL FIELD

The present invention relates to a drone for painting an outer wall of a high-rise building, and more particularly, a drone floating and moving in the air which is used to paint an outer wall of a high-rise building, so that painting costs for the high-rise building can be reduced, painting work can be simplified, personal accidents due to falls may be prevented, and a painting work time may be shortened.

### BACKGROUND ART

In general, in order to paint the exterior wall of a high-rise building, a worker uses a gondola installed on a roof of the building to suspend the workbench on a rope to move up and down, and directly paints the exterior wall while standing on the workbench. Otherwise, a worker may conduct painting work while descending on a rope fixed on the roof, in order to paint the exterior wall of a high-rise building.

As described above, the painting work may be carried out on the workbench installed on the gondola on the roof of the building or while descending on a rope, thereby having an advantage of meticulously painting the exterior wail of a building. However, since the worker should directly work at a high location on the exterior wail, they are always exposed to the risk of falling accidents, in particular, the risk of accidents increases on a day when wind blows strongly. Further, because the worker conducts painting work on a highly located place, there are disadvantages in that they do not freely move and, as a result, the painting work becomes slow and a work period is lengthened. Further, artificial painting work implemented by the worker who paints while directly descending on the exterior wall of a building entails a risk of life and thus duly involves inevitably high labor costs. Therefore, it is pointed out as a disadvantage that the higher the building, the higher the cost of painting the exterior wall of a building.

The above-described invention refers to a background technology in the technical field to which the present invention pertains, and does not mean the prior art.

Prior art documents in the technical field to which the present invention pertains include Korean Laid-Open Patent Publication No. 10-2010-0012421 or the like.

### DISCLOSURE

### Technical Problem

The present, invention has been conceived to solve the above-described problems in the related art, and an object of the present invention is to provide a drone for painting an outer wall of a high-rise building such as a skyscraper, wherein the drone may float and move in the air to paint the outer wall of the high-rise building, whereby painting costs of the high-rise building can be reduced, painting work may be simplified, personal accidents due to falls may be prevented, and a painting time can be shortened.

### Technical Solution

The present invention provides a painting drone designed to float and move in the air, which includes a drone body and a floating transfer unit to float and move the drone body in the air, wherein the drone body is provided with: a camera unit to photograph an outer surface of a building; a drive wheel mounted on one side thereof in order to guide the drone to the outer surface of the building; a buffer angle member formed to buffer (or absorb) impact with the building; and a painting nozzle member to inject paint to the outer surface of the building so as to paint the same.

Further, the drone body may be provided with a connection guide to connect the drone to a safety support provided in the building, wherein the connection guide may include connection rings formed on the drone body, a lifting motor to be mounted on the safety support, and a safety wire for connecting the connection rings the lifting motor.

Further, the drone body may be provided with a painting nozzle rotating means to inject paint onto the outer surface of the building while rotating the painting nozzle member, wherein the painting nozzle rotating means may include: an operating hole formed on a top surface of the drone body; a guide bearing fitted into the operating hole; a rotary shaft in which a lower end thereof is coupled to the guide bearing fitted into the operating hole in order to rotate the rotary shaft and an upper end thereof is connected to the painting nozzle member; and a transfer cylinder fixed to the top surface of the drone body while having a transfer shaft hinge-coupled to the painting nozzle member.

Further, the drone body may be provided with a foreign material removing member to remove a foreign material or dust adhered to the outer surface of the building before injecting the paint through the painting nozzle member, wherein the foreign material removing member may include: a rail groove formed on the top surface of the drone body; a transfer cart having a guide roller mounted on a bottom surface thereof to be guided along the rail groove; a drive motor mounted on the top surface of the transfer cart; a driven rotational panel that is mounted on a rotational axis of the drive motor and is rotated by driving the drive motor; an elastic rotational, panel that is attached to the driven rotational panel and has elastic release pines formed on one side thereof; an elastic buffer panel mounted on one side of the transfer cart; a support panel attached to the elastic buffer panel; a transfer cylinder fixed to the top surface of the drone body to transport the transfer cart; an elastic coil spring in which one end is fixed to a transfer shaft of the transfer cylinder and the other end is fixed to the support panel to thus connect the transfer shaft and the support panel; and an air injection nozzle provided on the drone body to inject air to the outer surface of the building.

### Advantageous Effects

The drone for painting an outer wail of a high-rise building according to the present invention, which floats and moves in the air, may be used to paint the outer surface of the high-rise building, thereby attaining effects of reducing costs for painting the outer wall of the high-rise building, simplifying painting work, preventing personal accidents due to falls, and shortening a painting time.

### DESCRIPTION OF DRAWINGS

FIG. 1 is a perspective view showing a drone for painting the outer wall of a high-rise building according to the present invention.

FIG. 2 is a plan view showing the drone for painting the outer wail of a high-rise building according to the present invention.

FIG. 3 is a side view showing the drone for painting the outer wall of a high-rise building according to the present invention.

FIG. 4 is a perspective side view showing the drone for painting the outer wall of a high-rise building according to the present invention.

FIG. 5 is a diagram illustrating an installation state of the drone for painting the outer wall of a high-rise building according to the present invention.

FIG. 6 illustrates another embodiment of the drone for painting the outer wall of a high-rise building according to the present invention.

FIG. 7 is a diagram illustrating an operational state of the drone for painting the outer wall of a high-rise building according to the present invention.

FIG. 8 illustrates another embodiment of the drone for painting the outer wail of a high-rise building according to the present invention.

FIG. 9 illustrates another embodiment of the drone for painting the outer wail of a high-rise building according to the present invention.

### DETAILED DESCRIPTION OF PREFERRED EMBODIMENTS OF INVENTION

Hereinafter, preferred embodiments of the drone for painting the outer wall of a high-rise building according to the present invention will be described in detail with reference to the accompanying drawings. In this process, thicknesses of lines or sizes of components shown in the drawings may be exaggerated for clarity and convenience of description. Further, terms described later are those defined in consideration of functions in the present invention and may vary according to the intension of users or operators or customs. Therefore, definitions of these terms should be made based on contents throughout the present specification.

Further, the following examples are not intended to restrict the scope of the present invention but are present merely as examples, and there may be various embodiments implemented through the present technical idea.

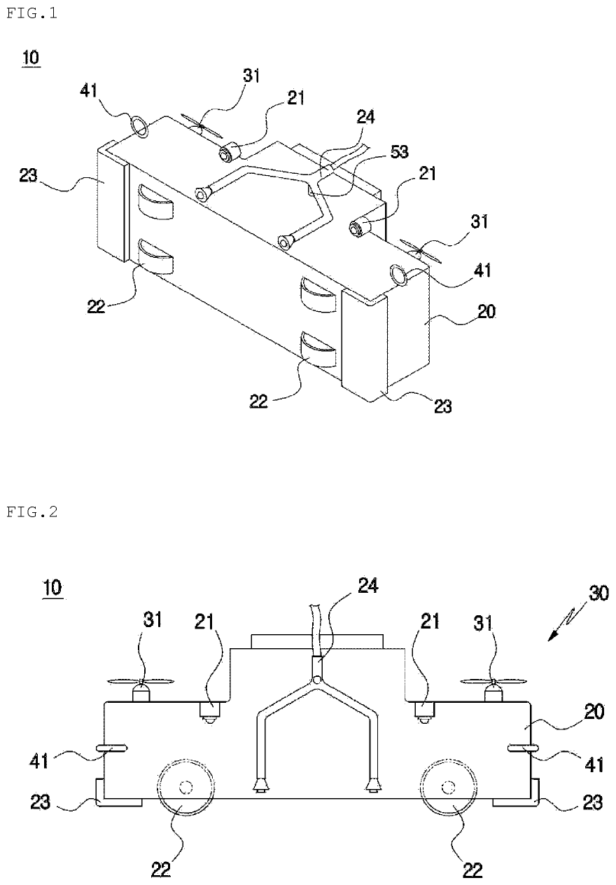

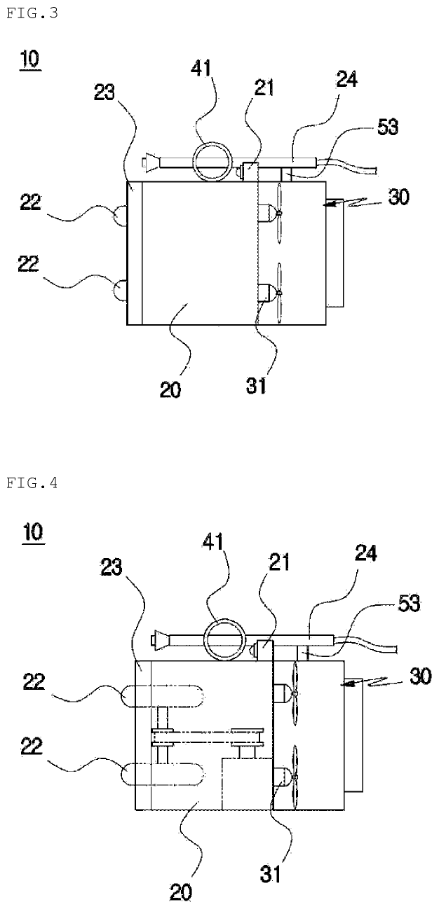

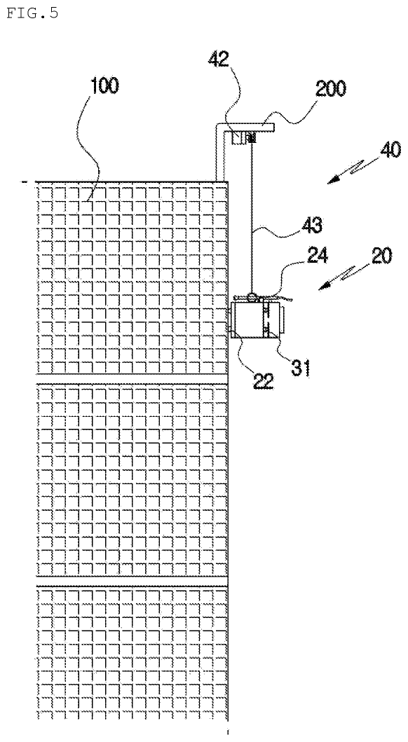

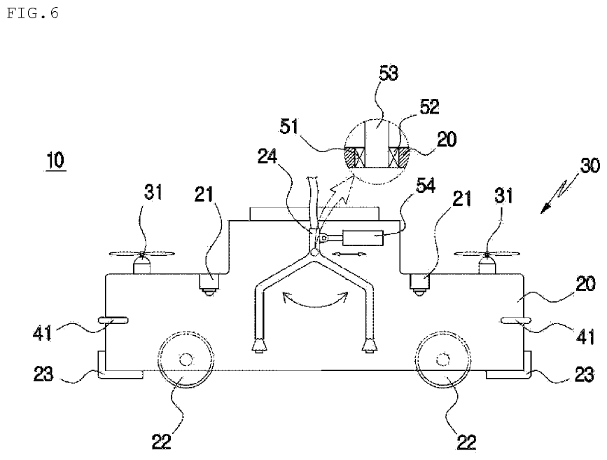

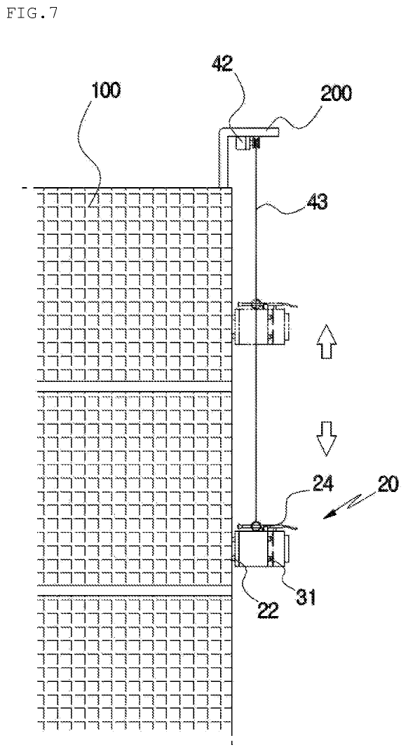

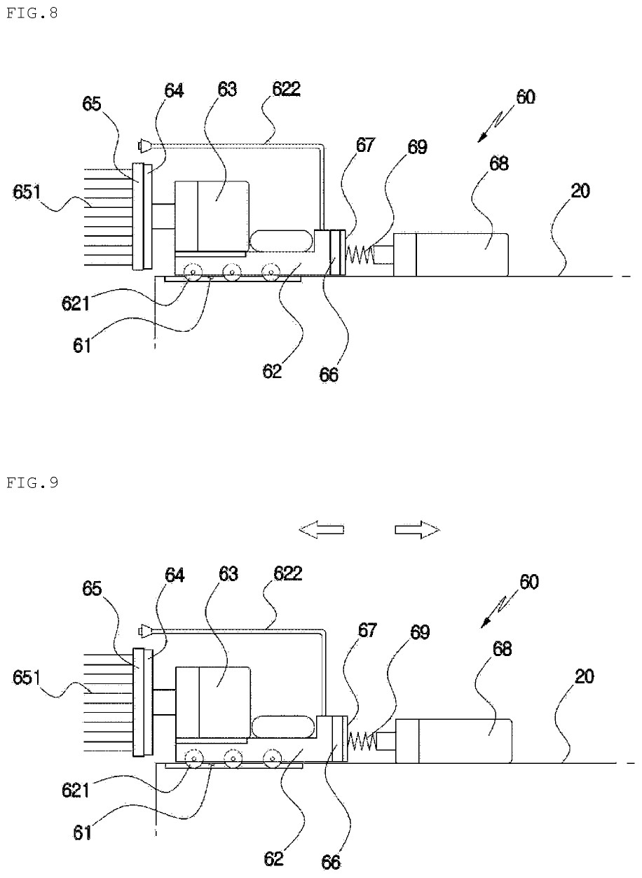

FIG. 1 is a perspective view showing a drone for painting the outer wall of a high-rise building according to the present invention; FIG. 2 is a plan view showing the drone for painting the outer wall of a high-rise building according to the present invention; FIG. 3 is a side view showing the drone for painting the outer wall of a high-rise building according to the present invention; FIG. 4 is a perspective side view showing the drone for painting the outer wall of a high-rise building according to the present invention; FIG. 5 is a diagram illustrating an installation state of the drone for painting the outer wall of a high-rise building according to the present invention; FIG. 6 illustrates another embodiment of the drone for painting the outer wall of a high-rise building according to the present invention; FIG. 7 is a diagram illustrating an operational state of the drone for painting the outer wall of a high-rise building according to the present invention; FIG. 8 illustrates another embodiment of the drone for painting the outer wall of a high-rise building according to the present invention; and FIG. 9 illustrates another embodiment of the drone for painting the outer wall of a high-rise building according to the present invention.

As shown in the drawings, a drone 10 for painting an outer wall of a high-rise building (hereinafter referred to as a “painting drone” for convenience of description) floats and moves in the air while injecting paint on an outer surface of the building 100, and may include a drone body 20 and a floating transfer unit 30.

The drone body 20 may be made of a synthetic resin or metal material, and may be formed in a rectangular housing structure. The drone body 20 may also be formed in a circular or polygonal housing structure other than the rectangular form.

Alternatively, the drone body 20 may be possibly formed in a rectangular, circular or polygonal panel structure or a frame structure.

The floating transfer unit 30 is for floating and moving the drone body 20 in the air, and may include a floating motor provided in the drone body 20, as well as floating units 31 consisting of floating wings that are connected to an axis of the floating motor for rotation. The floating motor may be seated and fixed inside a protective cap screwed to an outer surface of the drone body 20, and the floating wings may be fitted and fixed in an axis arranged outside through the protective cap.

The floating units 31 may be installed on a rear side of the drone body 20 to move the drone body 20 toward the outer surface of the building 100. Further, the floating units 31 may be provided on a top surface of the drone body 20 to float the drone body 20 in the air.

Specifically, four of the floating units 31 may be mounted on the rear side of the drone body 20 while the remaining four of the floating units may be provided on the top surface of the drone body.

The floating motor may be supplied with electricity by a battery provided inside the drone body 20, or may be connected by electric wires to possibly receive electricity from the outside.

Further, a camera unit 21 may further be provided on the drone body 20 through thread-coupling in order to photograph the outer surface of the building 100, and the drone body 20 may further be provided with a drive wheel 22 on one side thereof, which guides the drone body 20 to the outer surface of the building 100 and prevents collision to the building 100, a buffer angle member 23 made of a synthetic resin material having elasticity at an edge portion thereof may be attached to the drone body 20 in order to buffer (or absorb) impact with the building 100, and a painting nozzle member 24 may be formed on the drone body 20 in order to inject paint on the outer surface of the building 100 to complete painting.

Further, the drone body 20 may be provided with a wireless transmission and reception member, wherein image information photographed by the camera unit 21 may be transmitted to a wireless controller through the wireless transmission and reception member and then checked, and wherein the floating motor may be controlled by the wireless controller to thus control movement of the drone body 20. Further, the drone body 20 may be provided with a central control unit, which is electrically connected with the wireless transmission and reception member and the floating motor, thereby receiving a control signal and controlling the floating motor.

The drive wheels 22 may be fixed to both ends of a pair of wheel shafts provided in the drone body 20, and the wheel shafts may be connected by a wheel driving motor and a belt provided inside a housing body, thereby moving through driving of the wheel driving motor. The wheel driving motor may be electrically connected to the central control unit.

While the drive wheel 22 presses the outer surface of the building 100 by driving the floating unit 31 mounted on the rear side of the drone body 20, the drone body 20 may move along the outer surface of the building 100 by driving the wheel driving motor. At the same time, the drone body may inject paint through the painting nozzle member 24 while moving, thereby painting the outer surface of the building 100.

At this time, the floating unit 31 provided on the top surface of the drone body 20 may play a role of moving the drone body 20 to a predetermined height in the air and then maintaining the moved height during painting.

Further, inside the drone body 20, a paint tank may be provided and connected with the painting nozzle member 24 in order to fill the tank with the paint, wherein a pump is mounted on the paint tank to feed the paint to the painting nozzle member 24. Otherwise, it is also possible that a connection hose is connected to the painting nozzle member in order to supply the paint from the outside (outside the building to be painted) to the painting nozzle member through a feed pump.

Herein, a guide fan may be screwed to an end of the painting nozzle member 24 to blow wind, so that the paint discharged from the painting nozzle member 24 is preferably prevented from blowing outward by the wind blowing from the outside, thereby eventually increasing feed efficiency of the paint to the outer wall.

Further, the drone body 20 may be provided with a connection guide 40 to connect the drone body to a safety support 200 provided in the building 100, wherein the connection guide 40 may include: connection rings 41 formed on the drone body 20; a lifting motor 42 to be mounted on the safety support 200; and a safety wire 43 to connect the connection rings 41 and the safety support 200, and wherein the drone body 43 may move up and down, as shown in the drawings, by driving the lifting motor 42. Therefore, it is not necessary to form the floating unit 31 on the top surface of the drone body 30.

The safety wire 43 is wound around a lifting axis of the lifting motor 42 and an end of the safety wire 43 is bundled and fixed to the connection rings 41.

Further, the drone body 20 may be provided with a painting nozzle rotating means 50 to inject the paint onto the outer surface of the building 100 while rotating the painting nozzle member, wherein the painting nozzle rotating means 50 may include: an operating hole 51 formed on the top surface of the drone body 20; a guide bearing 52 fitted into the operating hole 51; a rotary shaft 53 in which a lower end thereof is coupled to the guide bearing 52 fitted into the operating hole 51 in order to rotate the rotary shaft and an upper end thereof is connected to the painting nozzle member 24; and a pivot cylinder 54 screwed and fixed to the top surface of the drone body 20 while having a pivot shaft hinge-coupled to the painting nozzle member 24, so that the pivot shaft can move by driving the pivot cylinder 54 to rotate the painting nozzle member 24 so as to inject the paint, thereby widening a paint injection range.

Further, an extension cylinder may be welded on an upper end of the rotary shaft 53, and the painting nozzle member 24 may be screwed to an extension shaft of the extension cylinder to secure the painting nozzle member 24 through thread-coupling, so that a thickness of the painted layer is preferably regulated by adjusting a distance between the end of the painting nozzle member 24 and the outer wall of a building by driving the extension cylinder.

Further, the drone body 20 may be provided with a foreign material removing member 60 to remove a foreign material or dust adhered to outer surface of the building before injecting the paint through the painting nozzle member 24, wherein the foreign material removing member 60 may include: a rail groove 61 formed on the top surface of the drone body 20; a transfer cart 62 having guide rollers 621 mounted on a bottom surface thereof to be guided along the rail groove 61; a drive motor 63 mounted on a top surface of the transfer cart 62 through thread-coupling; a driven rotational panel 64 that is welded and fixed to a rotational axis of the drive motor 63 and is rotated by driving the drive motor 63; an elastic rotational panel 65 made of a synthetic resin material having elasticity, which is attached to the driven rotational panel 64 and has elastic release pins 651 formed integrally on one side thereof; an elastic buffer panel 66 made of a synthetic resin material having elasticity, which is screwed and fixed to one side of the transfer cart 62; a support panel 67 made of a synthetic resin material having elasticity, which is attached to the elastic buffer panel 66; a transfer cylinder 68 fixed to the top surface of the drone body 20 to transport the transfer cart 62; an elastic coil spring 69 in which one end is fixed to a transfer shaft of the transfer cylinder 68 and the other end is fixed to the support panel 67 through welding or thread-coupling to thus connect the transfer shaft and the support panel 67; and an air injection nozzle 622 provided on the drone body 20 to inject air to the outer surface of the building 100, in order to remove dust or foreign materials separated by the elastic rotational panel 65. The air injection nozzle 622 may be connected to a connection hose in order to receive compressed air from the outside.

When the transfer cart 62 moves by driving the transfer cylinder 68, the elastic rotational panel 65 and the elastic release pins 651 may press the outer surface of the building 100 while rotating the elastic rotational panel 65 by driving the drive motor 63, so as to release a foreign material or dust from the outer surface of the building 100, thereby improving release (cleaning) efficiency. Further, elastic action of the elastic coil spring 69 and the support panel 67 may buffer (or absorb) a pressing force of the elastic rotational pane 65 to press the outer surface of the building 100 and, at the same time, may prevent a window or an outer wall of the building 100 from being damaged due to the pressing force because the transfer cart 62 is moved by the guide roller 621 without friction, and may further improve release efficiency.

At this time, a vibration device, that is, a vibrator may be screwed and fixed to an upper portion of the transfer cart 62 so that vibration of the vibrator is transferred to the drive motor 63 and the elastic release pins 651 of the elastic rotational panel 65 through the transfer cart 62, which in turn is transferred to the outer wall and windows of the building, thereby preferably increasing the release efficiency and cleaning efficiency of the foreign material.

One embodiment of the present invention described above is merely illustrative, and those skilled in the art to which the present invention pertains will appreciate that various modifications and other equivalent embodiments are possible. Therefore, it will be appreciated that the present invention is not restricted to the form mentioned in the detailed description above. Accordingly, the true technical scope of the present invention to be protected should be determined by the technical spirit of the appended claims. In addition, the present invention is to be understood as including all modifications, equivalents and substitutes within the spirit and scope of the present invention as defined in the appended claims.

### DESCRIPTION OF REFERENCE NUMERALS

10: Painting drone 20: Drone body

21: Camera unit 22: Drive wheel

23: Buffer angle member 24: Painting nozzle member

30: Floating transfer member 31: Floating unit

40: Connection guide 41: Connection ring

42: Lifting motor 43: Safety wire

50: Painting nozzle rotating means 51: Operating hole

52: Suite bearing 53: Rotary shaft

54: Pivot cylinder 60: Foreign material removing member

61: Rail groove 62: Transfer cart

621: Guide roller 622: Air injection nozzle

63: Drive motor 64: Driven rotational panel

65: Elastic rotational panel 651: Elastic release pin

66: Elastic buffer panel 67: Support panel

68: Transfer cylinder 69: Elastic coil spring

100: Building 200: Safety support

1. A drone for painting an outer wall of a high-rise building, which floats and moves in an air, comprising a drone body and a floating transfer unit to float and move the drone body in the air,
wherein the drone body is provided with:
a camera unit to photograph an outer surface of a building;
a drive wheel mounted on one side thereof in order to guide the drone to the outer surface of the building;
a buffer angle member formed to buffer (or absorb) impact with the building; and
a painting nozzle member to inject paint to the outer surface of the building so as to paint the same.

2. The drone according to claim 1, wherein the drone body is further provided with: a connection guide to connect the drone to a safety support provided in the building, wherein the connection guide includes:
connection rings formed on the drone body;
a lifting motor to be mounted on the safety support; and
a safety wire for connecting the connection rings the lifting motor.

3. The drone according to claim 1, wherein the drone body is further provided with a painting nozzle rotating means to inject paint onto the outer surface of the building while rotating the painting nozzle member, wherein the painting nozzle rotating means includes:
an operating hole formed on a top surface of the drone body;
a guide bearing fitted into the operating hole;
a rotary shaft in which a lower end thereof is coupled to the guide bearing fitted into the operating hole in order to rotate the rotary shaft and an upper end thereof is connected to the painting nozzle member; and
a transfer cylinder fixed to the top surface of the drone body while having a transfer shaft hinge-coupled to the painting nozzle member.

4. The drone according to claim 1, wherein the drone body is further provided with a foreign material removing member to remove a foreign material or dust adhered to the outer surface of the building before injecting the paint through the painting nozzle member,
wherein the foreign material removing member includes:
a rail groove formed on the top surface of the drone body;
a transfer cart having a guide roller mounted on a bottom surface thereof to be guided along the rail groove;
a drive motor mounted on the top surface of the transfer cart;
a driven rotational panel that is mounted on a rotational axis of the drive motor and is rotated by driving the drive motor;
an elastic rotational panel that is attached to the driven rotational panel and has elastic release pins formed on. one side thereof;
an elastic buffer panel mounted on. one side of the transfer cart;
a support panel attached to the elastic buffer panel;
a transfer cylinder fixed to the top surface of the drone body to transport the transfer cart;
an elastic coil spring in which one end is fixed to a transfer shaft of the transfer cylinder and the other end is fixed to the support panel to thus connect the transfer shaft and the support panel; and
an air injection nozzle provided on the drone body to inject air to the outer surface of the building.
